(19) United States
(12) Patent Application Publication
(10) Pub. No.: US 2004/0173098 A1
(43) Pub. Date: Sep. 9, 2004

(54) Passive source of fresh water

(76) Inventor: Clayton D. Callihan, Jupiter, FL (US)

Correspondence Address: CLAYTON DALE CALLIHAN, 131 SAND PINE DR., JUPITER, FL, 33477, US

(21) Appl. No.: 10/379,503

(22) Filed: Mar. 5, 2003

(51) Int. Cl. B01D 53/02

(52) U.S. Cl. 96/108

(57) ABSTRACT

Water is collected from the air inside bubbles that contain salt to lower the vapor pressure of water. This reduced pressure inside the bubbles causes water to diffuse through the bubble walls until the relative humidity inside the bubbles reaches its dew point. When the dew point is reached the moisture condenses and drains out of the bubbles. After several cycles of collecting the water following the condensation, the water being released is essentially pure. The bubbles are formed from the water soluble cellulose derivative, methyl carboxymethyl cellulose. The relative humidity appears to not play a significant role in the amount of water collected. Methyl cellulose has been approved as a food additive by the Food and Drug Administration.

Although two thirds of the earth's surface is covered with water, there is a grave shortage of water in many areas around the world. The water from the oceans cannot be used for drinking water or for irrigation without first removing the salt. Those people living close to the ocean can obtain nearly salt free water by the use of hyper filtration or reverse osmosis. Unfortunately, these are expensive processes requiring literally thousands of meters of expensive tubing and continuous high pressure pumping of salt water through the tubes. The water that is collected must be distributed then to the cities and towns that need the water requiring the consumption of a great deal more energy.

Another very common way to obtain fresh water is from rain. Here water is evaporated from the surfaces of bodies of water, rising into the air and becoming dependent on the vagaries of the winds, topography, and temperatures. This means that some areas get rainfall and others receive essentially none. The process of evaporation and condensation can be duplicated by distillation.

Unfortunately, this requires the input of approximately 1,000 BTU per pound of water vaporized and an equal amount of heat removal in the condensation step. The heat required for vaporization in the oceans and lakes is supplied by the sun, but it is not nearly so easy to get adequate amounts of solar heat to vaporize water in factories that distill water.

This invention uses an entirely different approach. Water is currently escaping from every body of water on the earth's surface even if it is frozen. Some of that water returns to the earth's surface as rainfall. But, not all of it. Some of the water always remains dispersed in the atmosphere as humidity. This water is spread all over the earth's surface regardless of the proximity of the land to an ocean. The amount of vaporization that occurs depends on the temperature of the water because the heat needed for vaporization must come from somewhere.

It also depends on the relative humidity of the air directly above the water. If a water molecule trying to escape from the surface of the water collides with a molecule above it, that molecule will return to the water. Fortunately, for the people who need fresh water, there is always a breeze of some kind over the water's surface sweeping away the vaporized water molecules allowing evaporation to continue. Furthermore, the molecular weight of water is 18 while the molecular weight of air is 29. This means that the vaporized water molecules behave as a floating cork, that is, it naturally rises up away from the water's surface. The vaporized water contains essentially no salt except that which is entrained by wind currents. But even that falls out very shortly after becoming airborne. The vaporized water may contain very small amounts of pesticides or other organic molecules that are in the water. But one can be certain that the concentration will be many times less than it was in the starting body of water.

This invention takes advantage of the natural phenomena of vaporization where the heat for vaporization comes directly from the sun, followed by the distribution of water vapors in the earth's atmosphere. This invention shows that these water vapors can be collected inside tiny bubbles formed in water-soluble polymers. At night, when the ambient temperature goes down, condensation will occur inside the tiny bubbles and water will drain out through the bottom of the tiny polymer bubbles to be collected for drinking water or other applications.

Each of the tiny bubbles inside the water-soluble polymer contains salt. The salt lowers the vapor pressure of the water inside the bubbles. This decreased vapor pressure acts as a driving force to pull moisture inside the bubbles, causing them to fill up with saturated water vapor. Then at night, when the temperature drops, the dew point is exceeded inside the bubbles causing the moisture there to condense. All polymer chemists know that polymers are not soluble in salt water. So the water that has condensed will rapidly diffuse out through the bottom of the bubbles in accordance with the laws of mass action. Thus producing fresh clean water.

The basic reason that this device works so well is due to the rapid diffusion of water vapors through the walls of the bubbles that are formed inside the water-soluble polymer. Each tiny bubble has an outer surface that serves as a membrane through which water vapor must diffuse. The amount of water vapor that passes through a membrane per unit of time is called the membrane's permeability. Permeability is a strong function of the solubility of the membrane in the vapor being transported through the film, thus water-soluble polymer. It is also a function of the thickness of the film. In this case millions of tiny bubbles are formed with very thin surfaces. And, of course, permeability is a function of the exposed surface area. In this case the exposed surface area is the outside surface area of millions of tiny bubbles.

Finally, the amount of water vapor that passes through the walls of the bubbles are also dependent on the vapor pressure difference of the water between that on the inside and that on the outside. How much that difference is will largely depend on the salt concentration in the polymer. But here, there is a limit. When making the polymer that contains the bubbles, one has to make the composite in such a manner as to make the membranes which form the walls of the bubbles very organized and contiguous such that the membranes themselves have only molecular sized holes for diffusion.

The composition of the polymer, which forms the walls of the bubbles, must be such that it is soluble in water and contains a strong positively charged cat-ion to repel any salt atoms that that try to escape through the membrane. The net effect of this invention is to allow the sun to supply the heat needed to vaporize salt freewater to the atmosphere. Wind currents then transport the distilled water, referred to as humidity, to polymer based collection sites essentially any place in the world. These polymer sites draw the water molecules through membranes where larger organic molecules, which may be poisonous, cannot pass and therefore are eliminated from the condensed water.

This system will provide a source of pure fresh water for drinking or irrigation to people all over the world. And it will all be without the associated costs of high-pressure pumps, piping, purification, vaporization, and all the other associated charges. There is humidity in the air even in the center of deserts although it may not be as much as it would be close to an ocean. It should be noted, however, that the relative humidity does not seem to play a highly significant role in our method of producing water. That is, one must have water in the air to be able to collect any, but as pointed out above, there is humidity in the air all over the world, although it may not be as high in the desert as it would be close to an ocean. It is the difference in the vapor pressure of water between the inside of the bubbles and the outside that is important and not the absolute value of the pressure.

There is a limitation on the size of the polymer bubbles to provide optimum performance. When the water that has collected inside the bubbles condenses, the latent heat of condensation must be dissipated to the surroundings. The amount of heat released in condensation is exactly the same as that required for vaporization of the water in the first place. The volume of vapor that an individual bubble holds is a function of the radius of the bubble cubed, while the surface area of that same bubble, through which the heat must be dissipated during condensation, is a function of the radius squared.

This relationship shows that the bubbles should be larger to hold more water vapor but smaller to get rid of the heat generated by the condensation. Certain bubble sizes therefore may be more efficient in certain areas. For example, in those areas where the temperature at night goes quite low, larger bubbles would be more effective because they would collect more water vapor through the day and then be able to get rid of the heat of condensation better at night. The bubble size can be set in several ways. One would be to limit the volume of the reactor for a given amount of reactants. A second might be to add some salt at the beginning of the reaction to increase the nucleation and therefore the number of bubbles. The third might be to increase the amount of methyl chloride that is released or all of the above.

Getting precisely the correct amount of salt in the polymer is quite critical. As stated earlier, polymers do not have an unlimited ability to tolerate salt. But most water-soluble polymers can remain in solution in the presence of some salt. Certain solvents, particularly alcohols, enhance the salt-water tolerance of cellulose polymers. The critical problem here is to try to saturate the water-solvent mixture present during the reaction so that when salt is split out during the reaction, it will serve as nuclei for subsequent bubble formation with the methyl chloride. Notice that where salt is being formed during the reaction that the heat of reaction is also being released in exactly the same spot. This localized release of heat will cause liquid methyl chloride to vaporize and form uniform bubbles which will enclose the salt.

The preceding discussion shows why the methyl chloride should be added as a liquid and held as a liquid until all of the required bubbles have formed. If this is not done, the bubbles will be randomly sized without salt and be quite ineffective.

A problem could develop if the polymer was too water soluble so that it softened in the presence of liquid water. This problem could be remedied by simply increasing the degree of substitution of the methyl groups on the cellulose chains. Most cellulose derivatives go through several stages as the degree of substitution is increased. At low amounts of substitution the polymer is soluble in alkali, at higher substitution it becomes water-soluble. If the amount of substitution is increased still further, the product loses its hydrophilic character and becomes soluble only in organic solvents. For this application, it would be preferable to be on the high end of the water soluble range. This can be accomplished by increasing the amount of caustic added in the first stage.

### EXAMPLE

One hundred and sixty two parts of ground and bleached wood pulp was suspended in 2162 parts of a mixture of 95% tertiary butyl alcohol and 5% isopropyl alcohol.To this mixture 346 parts of 50% NaOH was added. Air was excluded from the mixture to avoid oxidative degradation. The suspension thus formed was stirred vigerously for 15 minutes to assure complete and uniform distribution of the reactants.

The scraped surface reactor was then sealed and carefully evacuated. The vacuum was replaced with oxygen free nitrogen and then evacuated again. This was repeated 2 more times and then the vacuum was replaced with 243 parts of methyl chloride. The reactor was at 18 degrees Centigrade. The reactor was stirred for 15 minutes to assure complete distribution of the methyl chloride in the mixture. The temperature was then very slowly brought up in 15 minutes to 44 degrees Centigrade with vigorous mixing. Over this period, 54 parts of methyl chloride was taken off to recovery through a vent line. At the end of 15 minutes, the temperature was brought to 66 degree centigrade where the pressure was 60 psig. The temperature was then increased slowly to 70 degrees over one and one half hours and the pressure by then had dropped to 17 psig. The temperature was then brought to 95 degrees over the next hour.

The reactor was cooled and evacuated and 30 parts of monochloro acetic acid dissolved in 54 parts of 95% t.butyl alcohol and 5% isopropyl alcohol was added. The temperaure was slowly brought up to 74 degrees over a two hour period. The reactor was then cooled once more and 1080 parts of acetone was added and sirred into the reaction mass. The reactor at this point was completely filled. After 10 minutes of stirring the reactor was dumped.

Seventy seven parts of the wet reaction mass was placed on an open desk. The next morning the sample was standing in liquid. The liquid was taken up and the second morning the sample was again found standing in liquid.This occurred every morning with essentially the same amount of water being released each day irregardless of the relative humidity. This sample actually contained only about 3.7 parts of the substituted cellulose. The remainder was salt, water, solvent, by-products etc. The amount of water produced each day was 2 to 3 times the weight of the cellulose derivative. The amount varied slightly because of air currents, temperature etc.

The water collected after the first 3 or 4 days appeared to be quite pure because the contaminants, those just mentioned, were washed out by the condensed liquid draining out of the sample on the previous days. The alcohols that were present in the sample slowly evaporated after initial exposure to the air.

Application

A small amount of this polymer placed at the foot of a seedling would insure watering of that tree for the life of the polymer. Like most organic polymers, this material would be degraded over time by the UV rays of the sun. Covering the polymer with a thin layer of soil would allow the polymer to breathe while partially protecting it from harmful light rays that the sun may emit A person traveling across a desert would find a bottle of water that had been collected the night before from this polymer very desirable. Strips of the polymer placed on the side of a dry hill might cause the growth of vegetation that would be highly beneficial to the farmer.

Our armed forces fighting in arid lands would find a source of clean fresh water, like that that could be obtained from these polymer bubbles, to be a valuable asset. Many people are uncomfortable with the high humidity they encounter in many areas of the country, It may be possible to control the relative humidity inside a home by using this polymer to collect moisture from the air during the day and then discharging it at night when the ambient temperature has dropped below the dew point.

Properly harnessed, the heat released during the condensation step could be used to supply heat to the house. Or for those areas where evaporative cooling is ineffective due to high relative humidity, this polymer could be used to remove enough moisture from the air so that the evaporative cooling would work. Ships could obtain a supply of fresh water while they are at sea a long distance from a source of fresh water. Currently they must either carry enough water in large tanks to last them for the duration of their cruise or use hyper-filtration. The later requires the consumption of large amounts of energy for pumping and uses a tremendous amount of plastics tubing. This invention, on the other hand, would require essentially no man-made energy to make fresh water. The sun would supply the energy for vaporization and cooling breezes would carry away the heat generated during condensation.

1. What I claim is the manufacture of hollow spheres who's walls are made of plastic film permeable to both water vapor and liquid water. These spheres should contain an entrapped desiccant such as salt to lower the vapor pressure of water inside the spheres. Water vapor will then diffuse into the bubbles from the humidity in the surrounding air filling them with water. The water vapors inside the bubbles will condense when the temperature drops below its dew point and water will drain out to provide a source of uncontaminated fresh water.

2. I claim a technique for making a polymer that contains water permeable bubbles with salt trapped inside them. These bubbles will collect water through the day and automatically discharge it at night when the temperature drops below the dew point of the moisture collected inside the bubbles. The polymeric membranes are made to contain a positive cat-ion to prevent the escape of the salt from the bubbles. This makes the water collected from the bubbles into pure drinking water.

3. I claim a cellulose polymer with a degree of substitution of methyl groups of 1.0 to 2.5 and between 0.15 to 1.0 sodium carboxyl methyl groups. This polymer is then used to make the outside membranes of hollow spheres that allow the diffusion of water either as a vapor or liquid but not salt. The polymer can be made less hydrophyllic to prevent errosion by water leaving the bubbles by operating on the high end of the recommended degree of substitution or by adding 1 to 10 parts of epichlorohydrin with the monochloro acetic acid.

4. I claim the use of methyl chloride as a blowing agent to form spheres with salt inside during the manufacture of methyl carboxy methyl cellulose. By vaporizing and/or removing part of the methyl chloride while the primary substitution reaction is proceeding allowing the formation of spheres which contain some of the salt that is made as a by-product of the main substitution reaction.

5. I claim that any water soluble polymer that is formed into thin walled bubbles that contain salt trapped inside, where the salt cannot diffuse out through the thin walls of the bubbles, should also serve as a means of producing fresh water. These bubbles could be made by introducing a volatile fluid like dimethyl ether, methyl chloride, propane, ethane, etc into the molten polymer by many different techniques. For example, in an extruder by forcing the molten mixture containing the volatile gas under high pressure out through orfices.

6. I claim that other salts such as calcium chloride, potassium chloride, magnesium chloride, magnesium nitrate, aluminum chloride etc. will lower the vapor pressure of water inside the bubbles. They could be added to the initial reaction mixture and should serve as nucleating agents for bubble formation. Their presence would have no effect on the primary reactions and if the bubbles are properly formed would also collect moisture from the air.
